(19) United States
(12) Patent Application Publication
(10) Pub. No.: US 2026/0116204 A1
(43) Pub. Date: Apr. 30, 2026

(54) METHOD OF PERSONALIZING REGENERATIVE BRAKING OF VEHICLE

(71) Applicants: Hyundai Motor Company, Seoul (KR); Kia Corporation, Seoul (KR)

(72) Inventor: Wook Hyun Han, Hwaseong-si (KR)

(73) Assignees: Hyundai Motor Company, Seoul (KR); KIA Corporation, Seoul (KR)

(21) Appl. No.: 19/191,670

(22) Filed: Apr. 28, 2025

(30) Foreign Application Priority Data
Oct. 29, 2024 (KR) 10-2024-0149340

(51) Int. Cl. B60L 7/18; B60K 35/22; B60K 35/28

(52) U.S. Cl. CPC B60L 7/18; B60K 35/22; B60K 35/28; B60K 2360/16; B60L 2240/12; B60L 2240/16; B60L 2250/26; B60L 2260/22

(57) ABSTRACT

Disclosed is a method of personalizing regenerative braking of a vehicle including collecting, by a controller, driving data of the vehicle, determining, by the controller, that a braking situation of the vehicle is a regenerative braking situation while coasting based on the driving data collected while the vehicle is driving, inputting a brake pedal sensor signal depending on operation of a brake pedal by a driver during regenerative braking while coasting into the controller, determining, by the controller, a driver preferred deceleration based on a brake pedal input value indicated by the brake pedal sensor signal whenever the driver operates the brake pedal, and generating, by the controller, a personalized regenerative braking map based on the determined driver preferred deceleration information.

### CROSS-REFERENCE TO RELATED APPLICATION

This application claims under 35 U.S.C. § 119(a) the benefit of priority to Korean Patent Application No. 10-2024-0149340 filed on Oct. 29, 2024, the entire contents of which are incorporated herein by reference.

### TECHNICAL FIELD

The present disclosure relates to a method of enabling personalized regenerative braking control based on different preferred deceleration and brake pedal sensitivity for each driver so that a driver may be induced to more actively use regenerative braking.

### BACKGROUND

The biggest advantage of eco-friendly vehicles that are driven by a motor, such as electric vehicles, hybrid electric vehicles, and fuel cell vehicles, compared to internal combustion engine vehicles is that they may recover consumed energy through regenerative braking by the motor.

Regenerative braking is braking that generates a vehicle deceleration through power generation of a motor that converts the kinetic energy (rotational energy transmitted through driving wheels) of a vehicle into electrical energy, and the vehicle deceleration may be controlled by adjusting a motor torque during regenerative operation, i.e., a regenerative braking torque.

Recently, technology in which the degree of regenerative braking is divided into a plurality of stages and a driver selects one of the plurality of stages to adjust and change the degree of regenerative braking of a vehicle to a desired level has been applied to passenger both vehicles and commercial vehicles.

In order to apply this technology, a regenerative braking map, as shown in FIG. 1, may be input and stored in advance in a controller of a vehicle, and FIG. 1 shows an example in which the degree of regenerative braking is adjusted to one selected from stages 0, 1, and 2.

As shown in FIG. 1, a regenerative braking torque (wheel torque) is a negative (−) torque and is expressed as a negative (−) value, and the larger the magnitude of the absolute value of the regenerative braking torque during regenerative braking, the greater the vehicle deceleration.

In addition, the higher the regenerative braking stage in the regenerative braking map, the larger the magnitude (magnitude of the absolute value) of the regenerative braking torque (wheel torque) under the same vehicle speed condition. Because a larger magnitude (magnitude of the absolute value) of the regenerative braking torque means that regenerative braking power is greater and a regenerative braking amount is greater, as the generative braking stage becomes higher, the regenerative braking amount increases and thus causes increase in the vehicle deceleration and increases in a battery charging amount.

Referring to the example of FIG. 1, the regenerative braking map is set so that, when stages 0, 1, and 2 are applied at a vehicle speed of 20 to 100 km/h, constant decelerations of 0.02 g, 0.1 g, and 0.18 g occur respectively, and in the range of a vehicle speed of 0 to 20 km/h, the regenerative braking torque and the regenerative braking amount are gradually reduced as the vehicle speed decreases.

In the regenerative braking map for each regenerative braking stage illustrated in FIG. 1, if a reference vehicle speed is 20 km/h, the regenerative braking torque that may control the vehicle deceleration to be a constant deceleration for each regenerative stage in a vehicle speed range higher than the reference vehicle speed is set to a constant value.

In addition, in the regenerative braking map for each regenerative braking stage, the regenerative braking torque is set to a value depending on the vehicle speed even in the section from 0 km/h to the reference vehicle speed, but in this vehicle speed section, the regenerative braking torque is set to a gradually smaller value and converges on 0 as the vehicle speed decreases.

This is for intervention of the existing mechanical braking systems that perform friction braking, etc. for braking stability and reliability as the vehicle speed gets closer to 0 within the range below the reference vehicle speed. In addition, it may be confirmed that the magnitude (magnitude of the absolute value) of the regenerative braking torque is set to a larger value in the entire vehicle speed section as the stage is higher.

Meanwhile, regenerative braking starts at the moment when a driver takes his/her foot off an accelerator pedal. In addition, the regenerative braking torque is maintained even when a brake pedal is operated, and according to the example of FIG. 1, the regenerative braking torque gradually decreases below 20 m/h.

In the above-described regenerative braking, conventionally, because it was impossible to change and adjust regenerative braking stages and a deceleration for each stage, which were set by a vehicle manufacturer after a vehicle was released, in the case of some drivers, if excessive regenerative braking was applied compared to a deceleration desired by a driver, the driver may repeatedly depress the accelerator pedal or take his/her foot off the accelerator pedal, thereby leading to a decrease in vehicle fuel efficiency.

FIG. 2 is a view explaining conventional problems and, as shown in this figure, whenever a vehicle deceleration greater than a driver's desired deceleration occurs due to regenerative braking, a driver continues to depress and take his/her foot off an accelerator pedal.

In addition, because regenerative braking starts at the moment when the driver takes his/her foot off the accelerator pedal, and a negative torque by a motor is suddenly applied to vehicle wheels, the driver or passengers may feel a great sense of incongruity and thus lead to increased emotional dissatisfaction.

As such, if the driver feels the excessive regenerative braking torque or is dissatisfied with the sudden torque generation and the sense of incongruity, the driver may select a lower stage (e.g., stage 0) as the regenerative braking stage.

However, if the regenerative braking torque and the deceleration are reduced to preset values, the driver may continue to experience insufficient regenerative braking usage, and vehicle energy efficiency may deteriorate significantly.

The above information disclosed in this Background section is only for enhancement of understanding of the background of the disclosure and therefore it may contain information that does not form the prior art that is already known in this country to persons of ordinary skill in the art.

### SUMMARY OF THE DISCLOSURE

The present disclosure has been made in an effort to solve the above-described problems associated with the prior art, and it is an object of the present disclosure to provide a method of enabling personalized regenerative braking control based on different preferred deceleration and brake pedal sensitivity for each driver so that a driver may be induced to more actively use regenerative braking.

The objects of the present disclosure are not limited to the above-mentioned objects, and other objects not mentioned herein will be clearly understood by persons of ordinary skill in the art to which the present disclosure pertains (referred to as “those skilled in the art”) from the following description.

In one aspect, the present disclosure provides a method of personalizing regenerative braking of a vehicle including collecting, by a controller, driving data of the vehicle, determining, by the controller, that a braking situation of the vehicle is a regenerative braking situation while coasting based on the driving data collected while the vehicle is driving, inputting a brake pedal sensor signal depending on operation of a brake pedal by a driver during regenerative braking while coasting into the controller, determining, by the controller, a driver preferred deceleration based on a brake pedal input value indicated by the brake pedal sensor signal whenever the driver operates the brake pedal, and generating, by the controller, a personalized regenerative braking map based on the determined driver preferred deceleration information.

In a preferred embodiment, the method may further include controlling, by the controller, a display device to output a message configured to recommend experience of a regenerative braking personalization mode, and if the driver selects the experience of the regenerative braking personalization mode through an input device, controlling, by the controller, regenerative operation of a motor with a regenerative braking torque determined by the personalized regenerative braking map.

In another preferred embodiment, in determining the driver preferred deceleration, the controller may determine the driver preferred deceleration based on the brake pedal input value indicated by the brake pedal sensor signal input during the regenerative braking while coasting when a vehicle speed is a set speed or higher.

In still another preferred embodiment, the controller may be provided with a brake pedal map configured such that a braking deceleration is set to a value depending on the brake pedal input value, and determining the driver preferred deceleration may include determining an average value of peak values of brake pedal input values indicated by brake pedal sensor signals collected whenever the driver operates the brake pedal, and determining a deceleration corresponding to the average value of the peak values in the brake pedal map as the driver preferred deceleration.

In yet another preferred embodiment, the controller may be provided with a brake pedal map configured such that a braking deceleration is set to a value depending on the brake pedal input value, and determining the driver preferred deceleration may include determining peak values of brake pedal input values indicated by brake pedal sensor signals collected whenever the driver operates the brake pedal, determining decelerations corresponding to the respective peak values of the brake pedal input values from the brake pedal map, and determining an average value of the determined decelerations as the driver preferred deceleration.

In still yet another preferred embodiment, the personalized regenerative braking map may be a map configured such that a regenerative braking torque is set to a value depending on a vehicle speed, and the set regenerative braking torque in the personalized regenerative braking map may be a regenerative braking torque configured to be capable of controlling a vehicle deceleration to be the driver preferred deceleration during the regenerative braking while coasting.

In a further preferred embodiment, the controller may be provided with a plurality of regenerative braking stages set to be selectable and a preset regenerative braking map is provided for each of the regenerative braking stages and, in generating the personalized regenerative braking map, the controller may generate the personalized regenerative braking map based on map values of the preset regenerative braking map provided for each of the regenerative braking stages and the driver preferred deceleration.

In another further preferred embodiment, the preset regenerative braking map may be a map configured such that a regenerative braking torque is set to a value depending on the vehicle speed, and the regenerative braking torque may be set to be capable of controlling the vehicle deceleration to be a deceleration predetermined for each of the regenerative braking stages.

In still another further preferred embodiment, in generating the personalized regenerative braking map, the controller may generate the personalized regenerative braking map by determining regenerative braking torques, which are map values of the personalized regenerative braking map, by interpolation or extrapolation for an entire range of the vehicle speed based on the deceleration predetermined for each of the regenerative braking stages, the driver preferred deceleration, and the regenerative braking torque for each vehicle speed of the preset regenerative braking map.

In yet another further preferred embodiment, in the personalized regenerative braking map, the regenerative braking torque in a vehicle speed range higher than or equal to a predetermined reference vehicle speed may be set to a constant value corresponding to the driver preferred deceleration, and in the preset regenerative braking map provided for each of the regenerative braking stages, the regenerative braking torque in the vehicle speed range higher than or equal to the reference vehicle speed may be set to a constant value corresponding to the deceleration predetermined for each of the regenerative braking stages.

In still yet another further preferred embodiment, the method may further include controlling, by the controller, regenerative operation of a motor with a regenerative braking torque determined by the personalized regenerative braking map, in a state in which a regenerative braking personalization mode is selected by the driver.

In a still further preferred embodiment, the method may further include determining, by the controller, a driver preferred regenerative braking entry slope from the brake pedal sensor signal input whenever the driver operates the brake pedal, and if the driver takes his/her foot off an accelerator pedal while the vehicle is driving, the controller may change the regenerative braking torque at the driver preferred regenerative braking entry slope from a point in time when the accelerator pedal is off until the regenerative braking torque reaches a regenerative braking torque corresponding to a map value of the personalized regenerative braking map.

In a yet still further preferred embodiment, if the driver takes his/her foot off the accelerator pedal while the vehicle is driving when the vehicle speed is a set speed or higher, the controller may change the regenerative braking torque at the driver preferred regenerative braking entry slope from the point in time when the accelerator pedal is off.

In another further preferred embodiment, determining the driver preferred regenerative braking entry slope may include determining deceleration slopes from brake pedal sensor signals input whenever the driver operates the brake pedal, during regenerative braking while coasting, determining an average value of the deceleration slopes whenever the driver operates the brake pedal, converting the average value of the deceleration slopes into a regenerative braking torque slope, and determining the converted regenerative braking torque slope as the driver preferred regenerative braking entry slope.

In still another further preferred embodiment, in determining the deceleration slopes, the controller may determine each of the deceleration slope as a value obtained by differentiating a corresponding one of the brake pedal sensor signals with respect to time.

In yet another further preferred embodiment, in determining the driver preferred regenerative braking entry slope, the controller may determine the driver preferred regenerative braking entry slope from the brake pedal sensor signal input during regenerative braking while coasting when the vehicle speed is a set speed or higher.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram illustrating a conventional regenerative braking map;

FIG. 2 is a diagram explaining conventional problems;

FIG. 3 is a block diagram illustrating the configuration of an apparatus for performing a regenerative braking personalization process of a vehicle according to the present disclosure;

FIG. 4 is a flowchart illustrating the regenerative braking personalization process according to the present disclosure;

FIG. 5 is a diagram illustrating actual vehicle driving data in the present disclosure;

FIG. 6 is a diagram illustrating a brake pedal map in the present disclosure;

FIG. 7 is a diagram illustrating a regenerative braking map based on a driver preferred deceleration in the present disclosure;

FIG. 8 is a diagram illustrating a regenerative braking torque changed by applying a personalized torque slope during a regenerative braking entry section in the present disclosure;

FIG. 9 is a diagram illustrating a deceleration slope when a driver operates a brake pedal along with actual vehicle driving data in the present disclosure; and

FIGS. 10 and 11 are diagrams illustrating regenerative braking torque changes and vehicle speed changes when the personalized slope is applied and when the personalized slope is not applied during the regenerative braking entry section in the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. Specific structural or functional descriptions set forth in the embodiments of the present disclosure will be merely exemplarily given to describe the embodiments depending on the concept of the present disclosure, and the embodiments depending on the concept of the present disclosure may be embodied in different forms. Further, the present disclosure should not be construed as being limited to the embodiments set forth herein, and it will be understood that the present disclosure includes all modifications, equivalents, or substitutes included in the spirit and technical scope of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof

The present disclosure relates a method of personalizing regenerative braking of a vehicle, and provides a method capable of inducing a driver to more actively use regenerative braking by providing a regenerative braking personalization mode in which map values of a regenerative braking map and a map value slope when entering regenerative braking are derived based on results of learning based on driving data of the vehicle and then the regenerative braking map is generated and applied.

The present disclosure may be applied to a vehicle that is equipped with a motor as a driving source for driving the vehicle and a driving device for driving the vehicle and may perform regenerative braking by the motor, for example, an electric vehicle and a fuel cell vehicle.

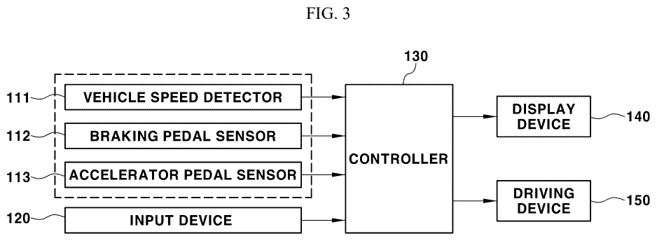

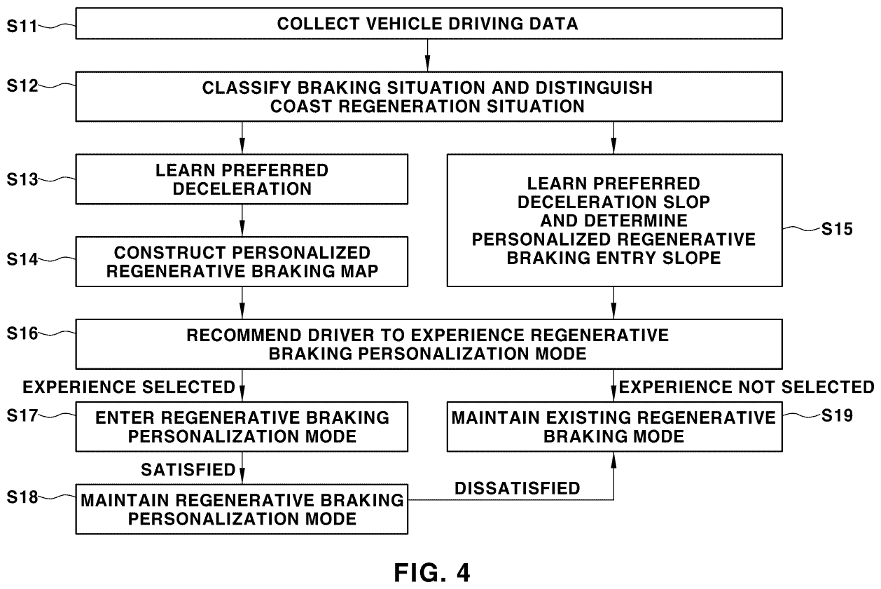

FIG. 3 is a block diagram illustrating the configuration of an apparatus for performing a regenerative braking personalization process of a vehicle according to the present disclosure, and FIG. 4 is a flowchart illustrating the regenerative braking personalization process according to the present disclosure.

As shown in FIG. 3, the apparatus for performing the regenerative braking personalization process is provided in the vehicle and includes a driver information detection unit 110, an input device 120, a controller 130, and a display device 140.

The driver information detection unit 110 serves to detect information indicating a vehicle driving status, i.e., vehicle driving information, and may include a vehicle speed detector 111 that detects a vehicle speed, a brake pedal sensor (BPS) 112 that detects a driver's brake pedal input value, and an accelerator pedal sensor (APS) 113 that detects a driver's accelerator pedal input value. In some implementations, the driver information detection unit 110 may be a hardware device implemented by various electronic circuits (e.g., computer, microprocessor, CPU, ASIC, circuitry, logic circuits, etc.).

The vehicle speed detector 111 may be a general wheel speed sensor that detects a wheel speed and, because the fact that vehicle speed information may be obtained from a signal from the wheel speed sensor is a well-known technical matter in the technical field to which the present disclosure pertains, a detailed description thereof will be omitted.

The BPS 112 is installed on a brake pedal and outputs an electrical signal depending on a driver's brake pedal operating state, and the APS 113 is installed on an accelerator pedal and outputs an electrical signal depending on a driver's accelerator pedal operating state.

Accordingly, the vehicle driving information in one embodiment of the present disclosure may include the vehicle speed detected by the vehicle speed detector 111, the brake pedal input value (BPS value, %) detected by the brake pedal sensor 112, and the accelerator pedal input value (APS value, %) detected by the accelerator pedal sensor 113.

The input device 120 is provided to input various information required in the regenerative braking personalization process in the present disclosure, and may be a general input device that enables driver input or operation in the vehicle. In some implementations, the input device 120 may be a hardware device implemented by various electronic circuits (e.g., computer, microprocessor, CPU, ASIC, circuitry, logic circuits, etc.). The input device 120 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s). In some implementations, the input device can include, but is not limited to, a touchscreen display, pedal sensor, accelerometer, vehicle speed sensor, user interface, GPS, etc.

The display device 140 is provided to display various display information required in the regenerative braking personalization process in the present disclosure, generated information, and messages for recommending and guiding experience of the regenerative braking personalization mode, and may be a general display device provided to display various information in a vehicle. In some implementations, the display device 140 may be a hardware device implemented by various electronic circuits (e.g., computer, microprocessor, CPU, ASIC, circuitry, logic circuits, etc.). The display device 140 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s). In some embodiments, the display device can include, but is not limited to, a touchscreen display, digital dashboard, head-up display (HUD), dedicated display screen located on the center console of the vehicle, LED indicator, etc.

In the present disclosure, the input device 120 and the display device 140 may be provided as a touchscreen capable of performing input and display functions in an integrated manner, i.e., a touchscreen of an audio, video and navigation (AVN) system mounted in the vehicle.

As shown in the drawings, the respective components of the driving information detection unit 110, the input device 120, and the display device 140 are connected to the controller 130. The controller 130 controls operation of a driving device 150 that drives the vehicle, and the driving device 150 may be a motor.

The motor generates and outputs driving power to drive the vehicle, and when the vehicle is braking or coasting, the motor is operated as a power generator to perform energy regeneration in which the kinetic energy of the vehicle is recovered as electrical energy.

In the present disclosure, the controller 130 collect driving data, which is the vehicle driving information, when the vehicle has driven more than a set milage (e.g., 1,000 km) (Operation S11 in FIG. 4), and distinguishes a regenerative braking situation during coasting (referred to as a coast regeneration situation) based on the collected driving data (Operation S12 in FIG. 4). The controller 130 according to an exemplary embodiment of the present disclosure may be a hardware device implemented by various electronic circuits (e.g., computer, microprocessor, CPU, ASIC, circuitry, logic circuits, etc.). The controller 130 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

Here, the driving data is vehicle driving information detected by the driving information detection unit 110, and may include the vehicle speed, the brake pedal input value (BPS value), and the accelerator pedal input value (APS value).

The distinguishment of the regenerative braking situation during coasting is performed only when the vehicle speed is a set speed (e.g., 30 km/h) or higher, and a learning process for regenerative braking personalization is performed only when the vehicle speed is the set speed or higher.

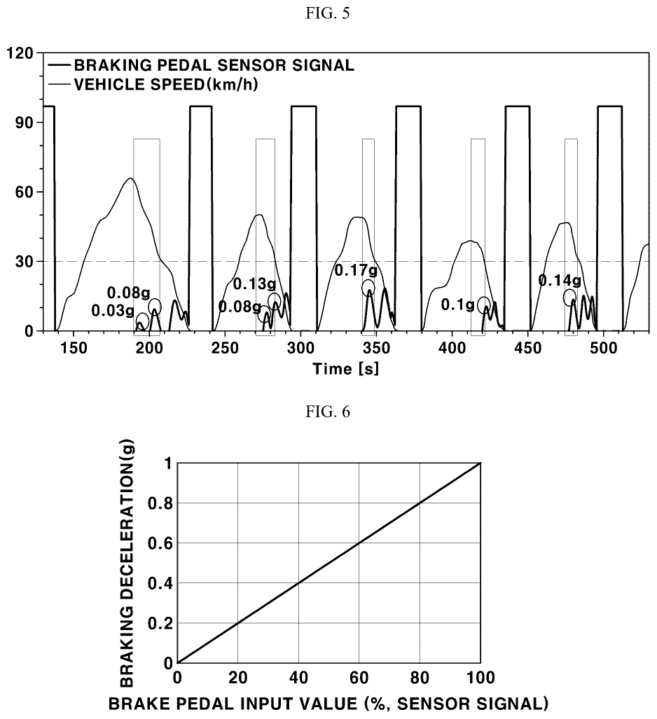

FIG. 5 is a diagram illustrating actual vehicle driving data in the present disclosure, and the brake pedal input value (brake pedal sensor signal value) and the vehicle speed are illustrated as braking data during actual driving.

As shown in this figure, in the present disclosure, the controller 130 receives the brake pedal sensor signal (brake pedal input value data) along with a real-time vehicle speed in order to determine and learn a driver preferred braking deceleration. In addition, the controller 130 receives an accelerator pedal sensor signal (accelerator pedal input value data).

A deceleration is determined from the brake pedal input value (BPS value, %) when the vehicle is braking by a brake pedal map, as shown in FIG. 6, and thereby, vehicle deceleration control may be performed based on the determined deceleration by the controller 130.

FIG. 6 is a diagram illustrating the brake pedal map in the present disclosure, as shown in this figure, the brake pedal map is a map in which the braking deceleration is set to a value depending on the brake pedal input value (BPS value, %) indicated by a brake pedal sensor signal.

In the present disclosure, in order to determine the driver preferred braking deceleration, the controller 130 should distinguish between regenerative braking during coasting (hereinafter referred to as coast regeneration) and regenerative braking depending on brake pedal input.

That is, braking situations of a vehicle may be broadly classified into two situations, and one of the braking situations of the vehicle is the coast regeneration situation, i.e., a braking situation in the state in which the driver takes his/her feet off both the brake pedal and the accelerator pedal, and in this situation, the driver wants to continue driving with an appropriate deceleration.

The driver preferred deceleration during coast regeneration is different depending on the driver. The coast regeneration situation may be said to correspond to a situation in which an engine brake or an exhaust brake in an internal combustion engine vehicle is used, and generally, the driver is familiar with a deceleration level when the driver takes his/her foot off the accelerator pedal while driving an internal combustion engine vehicle, i.e., a deceleration level when the accelerator pedal is off.

Considering this, it is possible to set the vehicle deceleration level that occurs when the accelerator pedal is off in a general internal combustion engine vehicle as a target of regenerative braking torque tuning in the present disclosure.

In the present disclosure, determination as to whether the braking situation of the vehicle is the coast regeneration situation may be performed by the controller 130 based on the signals from the brake pedal sensor 112 and the accelerator pedal sensor 113 of the driving information detection unit 110 and the vehicle speed information.

That is, the controller 130 may determine that the braking situation of the vehicle is the coast regeneration situation if the brake pedal and the accelerator pedal are in the off state and the vehicle speed is the set speed or higher. In the driving data illustrated in FIG. 5, the set speed is 30 km/h.

The remaining one of the braking situations of the vehicle is an active braking situation to stop the vehicle, which is a braking situation if there is a brake pedal input from the driver, i.e., when the brake pedal is in the on state, and may be said to be a situation in which the driver strongly depresses the brake pedal to actually stop the vehicle. In the present disclosure, the controller 130 may determine that the braking situation of the vehicle is the braking situation to stop the vehicle if the brake pedal is in the on state when the vehicle speed is lower than the set speed.

In general, if the vehicle is not decelerated at all in a situation in which the driver takes his/her foot off the accelerator pedal, the driver decelerates the vehicle by slightly depressing the brake pedal so as to generate a vehicle deceleration level that is preferred thereby. Then, if the vehicle needs to be stopped due to a vehicle ahead or a traffic light, the driver actively depresses the brake pedal to stop the vehicle.

In the present disclosure, it is necessary to distinguish between the two braking situations described above, i.e., the coast regeneration situation and the braking situation in which the brake pedal is operated to stop the vehicle, and as described above, if the vehicle speed is the set speed or higher and both the accelerator pedal and the brake pedal are in the off state, the braking situation of the vehicle may be determined as the coast regeneration situation, and if the vehicle speed is lower than the set speed and the brake pedal is in the on state, the braking situation of the vehicle may be determined as the active braking situation in which the brake pedal is operated to stop the vehicle.

The set speed may be determined by considering the laws of a country where the present disclosure is applied to vehicles, the speed limit of each country, etc. For example, if the speed limit of downtown roads is 50 km/h, the level of depressing the brake pedal is small up to about 30 km/h, which is more than half of the speed limit, in actual data, and below 30 km/h, the brake pedal input value gradually increases to stop the vehicle, and the brake pedal input value converges on the maximum value of 100% near 0 km/h.

In addition, because the speed limit of domestic/internal auxiliary braking laws is also 30 km/h, as shown in FIG. 5, the vehicle speed of 30 km/h may be determined as the set speed to distinguish and determine the two braking situations described above.

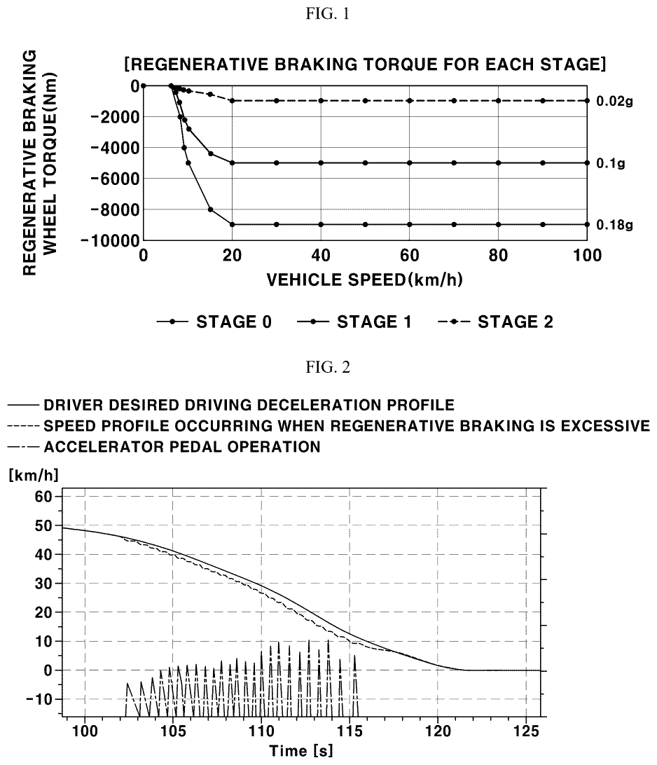

FIG. 5 shows data obtained when the vehicle is driven at the regenerative braking stage 0 (0.02 g) of FIG. 1. Referring to the regenerative braking map of FIG. 1, when the regenerative braking stage is 0 and the vehicle speed is the set speed of 30 km/h or higher, the deceleration is 0.02 g and this deceleration is a deceleration depending on the regenerative braking stage. The controller 130 may determine the deceleration depending on the regenerative braking stage from real-time regenerative braking stage information and vehicle speed information.

In addition, in the present disclosure, in order to determine the driver preferred deceleration for the coast regeneration situation (Operation S13 in FIG. 4), the controller 130 determines the average value of peak values (maximum values) of respective brake pedal input values (brake pedal sensor signal values) when the vehicle speed is the set speed of 30 km/h or higher. That is, the controller 130 determines the average of the maximum values of the brake pedal input values collected whenever the driver operates the brake pedal.

When the average of the maximum values of the brake pedal input values is determined, a deceleration corresponding to this average is determined from the brake pedal map shown in FIG. 6. This deceleration may be referred to as a preferred deceleration by the brake pedal.

Alternatively, the controller 130 may determine decelerations corresponding to the peak values of the brake pedal input values, i.e., the maximum values of the brake pedal input values collected whenever the driver operates the brake pedal, from the brake pedal map shown in FIG. 6, and then determine the average value of the decelerations as the preferred deceleration by the brake pedal.

In the example of FIG. 5, when the vehicle speed is the set speed of 30 km/h or higher, decelerations corresponding to the maximum values of the brake pedal input values are 0.03 g, 0.08 g, 0.08 g, 0.13 g, 0.17 g, 0.1 g, and 0.14 g (g is gravitational acceleration), and the average value thereof is 0.1 g.

Accordingly, the controller 130 may determine the driver preferred deceleration when the vehicle speed is the set speed of 30 km/h or higher as the sum of the deceleration of depending on the regenerative braking stage, which is 0.02 g, and the preferred deceleration by the brake pedal, which is 0.1 g, and may finally determine the acceleration of 0.12 g, which is the sum result, as the driver preferred deceleration in the coast regeneration situation (in the situation in which the driver takes his/her foot off the accelerator pedal) (Operation S13 in FIG. 4).

As described above, in the present disclosure, the average value (i.e., the preferred deceleration by the brake pedal) of the decelerations corresponding to the peak values of the brake pedal input values (the peak values of the brake pedal sensor signals) when the vehicle speed is the set speed (e.g., 30 km/h) or higher may be calculated, and the sum of the calculated average value and the deceleration depending on the regenerate brake stage (the preferred deceleration depending on the regenerative braking stage) applied during driving may be determined as a personalized driver preferred deceleration during coast regeneration.

Furthermore, in the present disclosure, the controller 130 generates a regenerative braking map based on the driver preferred deceleration using the previously set regenerative braking map data depending on the regenerative braking stage from the personalized driver preferred deceleration determined through the above-described learning process (Operation S14 in FIG. 4).

Thereafter, the controller 130 controls the regenerative operation of the motor using the generated regenerative braking map, and at this time, determines a regenerative braking torque (regenerative braking wheel torque) depending on the vehicle speed from the generated regenerative braking map, and then controls the regenerative operation of the motor based on the determined regenerative braking torque.

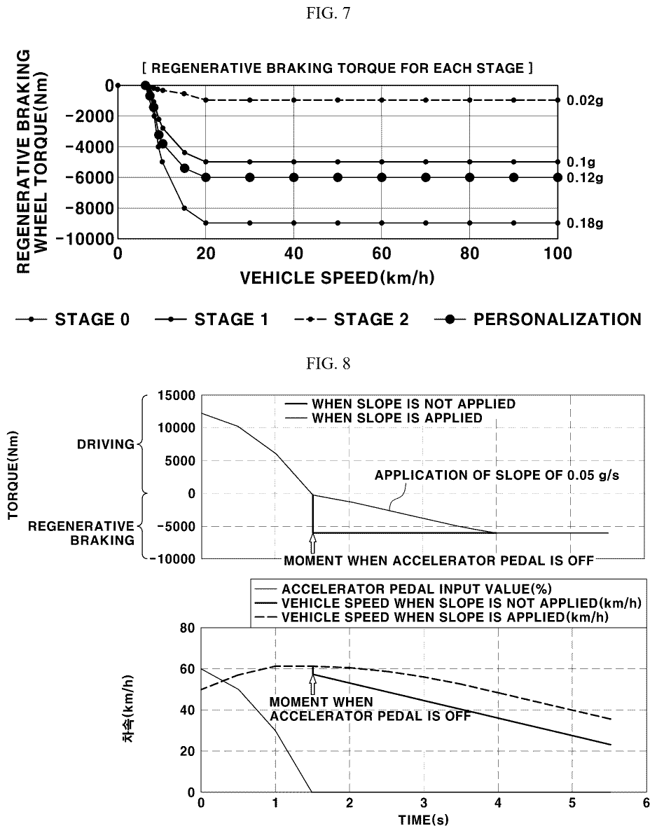

FIG. 7 is a diagram illustrating the regenerative braking map based on the driver preferred deceleration in the present disclosure, and a line of 0.12 g indicates the regenerative braking map based on the driver preferred deceleration (i.e., a personalized regenerative braking map).

Referring to this figure, a method of determining the regenerative braking map based on the driver preferred deceleration from the personalized driver preferred deceleration during coast regeneration will be described as follows.

In a process of generating a regenerative braking map line (line indicating map values) based on the driver preferred deceleration, if the personalized driver preferred deceleration is a value between the regenerative deceleration of the previously set regenerative braking stage 0 and the regenerative deceleration of the previously set regenerative braking stage 1, the controller 130 determines a value between the map values (regenerative braking torque values) of the regenerative braking maps of the two stages by linear interpolation from the map values, as a new map value, and generates a new regenerative braking map (line) from the new map value.

In the same manner, if the personalized driver preferred deceleration is a value between the regenerative deceleration of the previously set regenerative braking stage 1 and the regenerative deceleration of the previously set regenerative braking stage 2, the controller 130 determines a value between the map values (regenerative braking torque values) of the regenerative braking maps of the two stages by linear interpolation from the map values, as a new map value, and generates a new regenerative braking map (line) from the new map value.

If the personalized driver preferred deceleration exceeds the deceleration of the regenerative braking stage 2, the controller 130 determines a regenerate braking torque value corresponding to the personalized driver preferred deceleration by extrapolation based on a regenerative braking torque corresponding to the deceleration of the stage 2, and generates a new regenerative braking map (line) using this value as a new map value.

As a more specific example, if the driver preferred deceleration during coast regeneration is 0.12 g, this value is between the regenerative deceleration of the regenerative braking stage 1 and the regenerative deceleration of the regenerative braking stage 2 of the previously set regenerative braking map depending on the regenerative braking stage.

A regenerative braking value corresponding to 0.12 g between the regenerative deceleration of the regenerative braking stage 1, which is 0.1 g, and the regenerative deceleration of the regenerative braking stage 2, which is 0.18 g, of the existing regenerative braking map is determined based on the regenerative decelerations of the two stages, and thereby, a new regenerative braking map (a personalized regenerative braking map, indicated by a line marked with “personalization” in FIG. 7) is generated in a corrected form of the existing regenerative braking map.

That is, if the regenerative braking torque of the regenerative braking stage 1 is −4400 Nm (refer to the 0.1 g map of the stage 1) and the regenerative braking torque of the regenerative braking stage 2 is −8000 Nm (refer to the 0.18 g map of the stage 2) at a vehicle speed of 15 km/h, in order to construct a map of the personalized driver preferred deceleration of 0.12 g, a map value (regenerative braking torque value) corresponding to the vehicle speed of 15 km/h at 0.12 g is determined as “−4400+ (−8000−(−4400))×(0.12−0.1)/(0.18−0.1)=−5300 Nm”.

In addition, if the regenerative braking torque of the regenerative braking stage 1 is −5000 Nm (refer to the 0.1 g map of the stage 1) and the regenerative braking torque of the regenerative braking stage 2 is −9000 Nm (refer to the 0.18 g map of the stage 2) at a vehicle speed of 60 km/h, in order to construct the map of the personalized driver preferred deceleration of 0.12 g, a map value (regenerative braking torque value) corresponding to the vehicle speed of 60 km/h at 0.12 g is determined as “−5000+ (−9000−(5000))×(0.12−0.1)/(0.18−0.1)=−6000 Nm”.

In this way, the controller 130 generates a new regenerative braking map (personalized regenerative braking map) by determining map values (regenerative braking torque values) corresponding to personalized driver preferred decelerations during coast regeneration for the entire range of the vehicle speed in the existing regenerative braking map.

Further, if the driver preferred deceleration during coast regeneration is, for example, 0.2 g, which exceeds the regenerative braking stage 2, because the regenerative braking torque of the regenerative braking stage 2 at a vehicle speed of 15 km/h is −8000 Nm (see the 0.18 g map of the stage 2), in order to construct a map based on the personalized driver preferred deceleration, a map value (regenerative braking torque value) corresponding to the vehicle speed of 15 km/h is determined as “−8000×0.2/0.18=−8888 Nm”.

In addition, because the regenerative braking torque of the regenerative braking stage 2 at a vehicle speed of 60 km/h is −9000 Nm (see the 0.18 g map of the stage 2), in order to construct the map based on the personalized driver preferred deceleration, a map value (regenerative braking torque value) corresponding to the vehicle speed of 60 km/h is determined as “−9000×0.2/0.18=−10000 Nm”.

In this way, the controller 130 generates a new regenerative braking map (personalized regenerative braking map) by determining map values (regenerative braking torque values) corresponding to personalized driver preferred decelerations during coast regeneration for the entire range of the vehicle speed in the existing regenerative braking map.

After the new regenerative braking map based on the personalized driver preferred deceleration during coast regeneration has been generated using the above-described method, the regenerative braking torque of the motor may be controlled using the generated new regenerative braking map (personalized regenerative braking map).

However, if the regenerative braking torque is determined using the personalized regenerative braking map and the regenerative operation of the motor is controlled using the determined regenerative braking torque at the moment when the driver takes his/her foot off the accelerator pedal, a sense of incongruity in the vehicle behavior may occur.

FIG. 8 is a diagram illustrating a regenerative braking torque changed by applying a personalized torque slope during a regenerative braking entry section in the present disclosure. In FIG. 8, a torque indicating the positive (+) direction or a torque having a positive (+) value are a driving torque, and a torque indicating the negative (−) direction or a torque having a negative (−) value are a regenerative braking torque.

In the present disclosure, an increase and decrease in a regenerative braking torque means an increase and decrease in the magnitude of the absolute value of the regenerative braking torque, an increase in a regenerative braking torque means an increase in a regenerative braking amount, and a decrease in a regenerative braking torque means a decrease in a regenerative braking amount.

FIG. 8 illustrates regenerative braking torques when the personalized torque slope is not applied and when the personalized torque slope is applied, an accelerator pedal input value, and vehicle speeds depending on regenerative braking control when the personalized torque slope is not applied and when the personalized torque slope is applied.

As illustrated, if the regenerative braking map is applied without applying the personalized torque slope during an arbitrary time from the moment when the driver takes his/her foot off the accelerator pedal (the moment when the accelerator pedal is off) until the vehicle enters regenerative braking, the torque of −6000 Nm (e.g., the regenerative braking torque at a vehicle speed of 30 km/h or higher) in the 0.12 g map (personalized regenerative braking map) of FIG. 7 is rapidly reflected like a STEP function at the moment when the accelerator pedal is off.

As a result, vehicle speed cutoff may occur like the vehicle speed line when the personalized torque slope is not applied, as shown in FIG. 8, and this causes a sense of incongruity in the vehicle behavior during regenerative braking.

Accordingly, in the present disclosure, when applying the personalized regenerative braking map, the regenerative braking torque is gently changed by a personalized regenerative braking entry torque slope until the regenerative braking torque reaches the map value of −6000 Nm after the moment when the accelerator pedal is off, thereby preventing occurrence of a sense of incongruity in the vehicle behavior.

That is, if the torque line of 0.12 g in FIG. 7 is referred to as the regenerative braking map based on the personalized driver preferred deceleration (hereinafter, “personalized preferred deceleration map”), the regenerative braking torque is changed from 0 Nm at the moment when the driver takes his/her foot off the accelerator pedal (the moment when the accelerator pedal off) to −6000 Nm, which is the map value of the personalized regenerative braking map of FIG. 7, with a gentle slope, thereby preventing occurrence of a sense of incongruity.

In order to prevent occurrence of the above sense of incongruity at the moment when the accelerator pedal is off, it is necessary to appropriately set the torque slope that changes the regenerative braking torque value from the point in time when the accelerator pedal is off until the regenerative braking torque reaches the map value of the personalized regenerative braking map.

In addition, it is necessary to gently increase the magnitude (magnitude of the absolute value) of the regenerative braking torque with the set torque slope until the regenerative braking torque reaches the map value (e.g., −6000 Nm).

The torque slope in the regenerative braking entry section from the point in time when the accelerator pedal is off may be set to a different value depending on the driver (Operation S15 in FIG. 4), and in detail, a personalized torque slope determined through a process of learning a driver preferred deceleration slope from driving data may be used. Here, the driving data may include the vehicle speed and the brake pedal input value.

If the torque slope is not applied in the regenerative braking entry section, the regenerative braking torque (e.g., −6000 Nm) corresponding to the map value of the personalized regenerative braking map should be suddenly applied at the moment when the driver takes his/her foot off the accelerator, and thus, vehicle speed cutoff and a sense of incongruity may occur, as shown in the lower graph of FIG. 8.

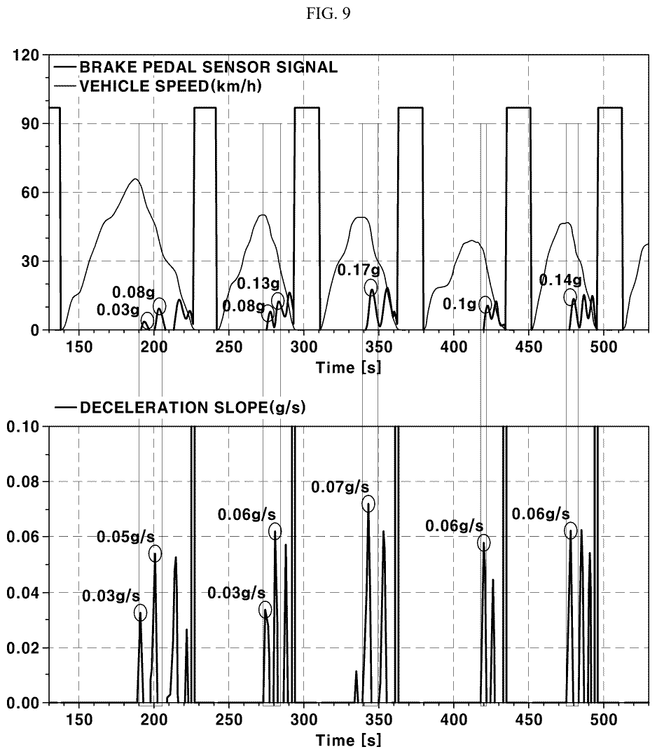

FIG. 9 is a diagram illustrating the deceleration slope when the driver operates the brake pedal along with actual vehicle driving data in the present disclosure, and explains a method of determining a personalized regenerative braking entry slope.

As illustrated, the vehicle speed and the brake pedal input value (brake pedal sensor signal) are illustrated as driving data (braking data) during coast regeneration while actual driving, and a deceleration slope (g/s) whenever the driver operates brake pedal is illustrated therebelow.

In the present disclosure, the controller 130 of the vehicle determines the personalized regenerative braking entry slope depending on the driver through the process of learning the driver preferred deceleration slope based on vehicle driving information detected by the driving information detection unit 110 (Operation S15 of FIG. 4).

Here, the vehicle driving information is the driving data of the corresponding driver collected while the vehicle is driving, and may include the brake pedal input value (BPS value, %), which is the braking data indicated by the brake pedal sensor signal, and the vehicle speed.

Referring to FIG. 9, a method of determining a regenerative braking torque slope to be applied to the regenerative braking entry section will be described. First, during coast regeneration when the vehicle speed is the set vehicle (e.g., 30 km/h) or higher, the controller 130 of the vehicle determines the deceleration slope (g/s) depending on the brake pedal input from the brake pedal sensor signal whenever the driver operates the brake pedal.

The deceleration slope may be calculated from a value obtained by differentiating the brake pedal sensor signal indicating the brake pedal input value with respect to time, and the deceleration slope (deceleration change rate) indicating the amount of deceleration change per unit time may be obtained by converting the obtained value into a value in units of g/s using the brake pedal map information of FIG. 6.

Referring to the example of FIG. 9, the deceleration slopes for each brake pedal input, which are obtained by differentiating the brake pedal sensor signal in a situation in which the vehicle speed is the set speed of 30 km/h or higher, are 0.03 g/s, 0.05 g/s, 0.03 g/s, 0.06 g/s, 0.07 g/s, 0.06 g/s, and 0.06 g/s (see the lower graph of FIG. 9), and the average value of these values is 0.05 g/s.

In one embodiment of the present disclosure, the driver preferred deceleration slope during coast regeneration is 0.05 g/s, and this deceleration slope is referred to as a slope (regenerative braking entry slope) that changes the regenerative braking torque in the regenerative braking entry section from the point in time when the accelerator pedal is off.

That is, if the regenerative braking torque and the vehicle deceleration during coast regeneration are proportional, the deceleration slope may be converted into a regenerative braking torque slope, and the regenerative braking torque may be changed with the converted regenerative braking torque slope.

In the present disclosure, the converted regenerative braking torque slope is the regenerative braking entry slope that may be used as a slope in the regenerative braking entry section, and this is a slope preferred by the driver and may be a personalized slope depending on the driver.

Accordingly, the magnitude (magnitude of the absolute value) of the regenerative braking torque may be increased so that the magnitude of the deceleration (magnitude of the absolute value of the deceleration when the deceleration is defined as having a negative (−) value) is increased with the slope of 0.05 g/s.

As described above, if the personalized deceleration slope is obtained and the regenerative braking torque in the regenerative braking entry section is changed by applying the obtained personalized deceleration slope (referring to the regenerative braking torque when applying the slope of 0.05 g/s in FIG. 8), the regenerative braking torque may be more gently changed from the moment when the driver takes his/her foot off the accelerator pedal, and occurrence of vehicle speed cutoff and a sense of incongruity may be prevented, compared to when the slope is not applied.

Referring to the upper graph of FIG. 8, it may be confirmed that, if the personalized regenerative braking map of 0.12 g is applied, and the regenerative braking torque is changed using the deceleration slope of 0.05 g/s as the regenerative braking entry slope so that the magnitude of the absolute value thereof increases from the moment when the driver takes his/her foot from the accelerator pedal until the regenerative braking torque reaches-6000 Nm, which is the map value of the personalized braking map, a total of 2.4 seconds is required. During this time, the regenerative braking torque may be gently changed from 0 Nm to −6000 Nm depending on the deceleration slope.

Referring to the lower graph of FIG. 8, it may be confirmed that, when the slope is not applied, the vehicle speed rapidly decreases at a point in time when the accelerator pedal input value becomes 0%, that is, when the accelerator pedal is off, but when the slope is applied, the vehicle speed gently decreases.

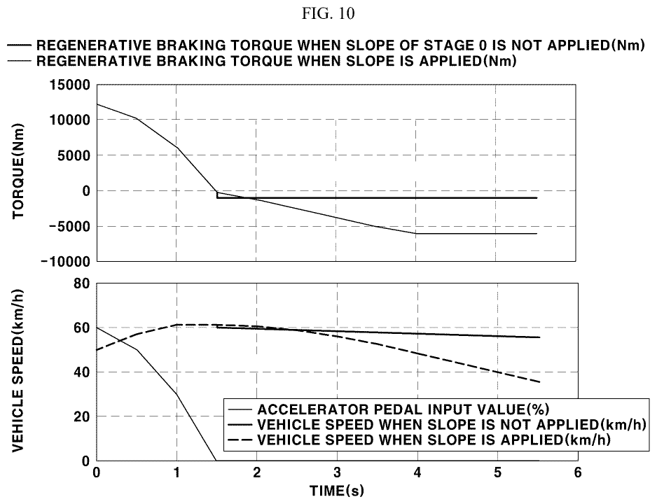

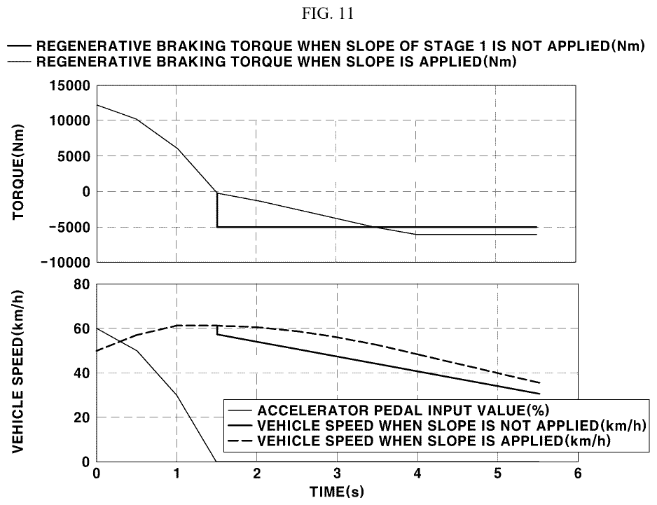

FIGS. 10 and 11 are diagrams illustrating regenerative braking torque changes and vehicle speed changes when the personalized slope (regenerative braking entry slope) is applied and when the personalized slope is not applied during the regenerative braking entry section in the present disclosure.

In FIGS. 10 and 11, the upper graph shows the regenerate braking torque change over time, and the lower graph shows the accelerator pedal input value (accelerator pedal sensor signal, %) and the vehicle change over time.

In addition, the regenerative braking torque change and the vehicle speed change when the slope is not applied, as shown in FIG. 10, represent a regenerative braking torque change and a vehicle speed change when the regenerative braking map of the regenerative braking stage 0 (referring to the 0.02 g line) illustrated in FIG. 7 is used.

In addition, the regenerative braking torque change and the vehicle speed change when the slope is not applied, as shown in FIG. 11, represent a regenerative braking torque change and a vehicle speed change when the regenerative braking map of the regenerative braking stage 1 (referring to the 0.1 g line) illustrated in FIG. 7 is used.

As illustrated, it may be confirmed that, when the slope is not applied, the regenerative braking torque changes rapidly at the point in time when the accelerator pedal is off, and the vehicle speed changes stepwise rather than linearly.

In the present disclosure, a mode in which the personalized regenerative braking map is applied is defined as a regenerative braking personalization mode. As described above, after the personalized regenerative braking map is constructed through the learning process based on the driving data of the driver and the personalized regenerative braking entry slope is obtained, the controller 130 may control operation of the display device 140 to output a message to recommend and encourage the driver to use the regenerative braking personalization mode (Operation S16 of FIG. 4).

At this time, as an example of a guidance message, a massage that informs the driver that the regenerative braking personalization mode has been tailored through learning based on the driver's driving data and that there are advantages and effects of using the regenerative braking personalization mode, i.e., an increased regenerative braking amount and improved braking feel, and allows the driver to select whether to experience the regenerative braking personalization mode may be displayed.

A specific example of the guidance message is as follows.

“The regenerative braking personalization mode has been tailored through learning based on your driving data. Would you like to experience this mode? (Upon entering the personalization mode, a regenerative braking amount is increased and braking feel is improved)”

If the driver selects the regenerative braking personalization mode, the controller 130 enters the regenerative braking personalization mode (Operation S17 of FIG. 4), and the regenerative braking personalization mode in which the regenerative braking torque is determined and the regenerative operation of the motor is controlled using the personalized regenerative braking map constructed through the learning process for the driver preferred deceleration and the personalized regenerative braking entry slope determined by the leaning process for the driver preferred deceleration slope is performed.

During the regenerative braking personalization mode, the controller 130 may generate and output a regenerative braking torque command using a regenerative braking torque determined by the personalized regenerative braking entry slope and the personalized regenerative braking map as a command value, thereby being capable of controlling the regenerative operation of the motor depending on the regenerative braking torque command.

During the regenerative braking personalization mode, if the driver is satisfied with the vehicle deceleration and a result of the regenerative braking personalization mode (Operation S18 of FIG. 4), the driver may maintain the regenerative braking personalization mode, but if not, the driver may release the regenerative braking personalization mode and return to a mode using the previously set regenerative braking map.

On the other hand, if the driver does not select the regenerative braking personalization mode, the controller 130 may determine a regenerative braking torque depending on a real-time vehicle speed using the previously set regenerative braking map (Operation S19 of FIG. 4), and control the regenerative operation of the motor based on the determined regenerative braking torque.

As such, the embodiments of the present disclosure have been described in detail. The above-described method of personalizing regenerative braking of the vehicle enables personalized regenerative braking control based on different preferred deceleration and brake pedal sensitivity for each driver so that a driver may be induced to more actively use regenerative braking.

Particularly, in the present disclosure, the regenerative braking deceleration is set based on the driver preferred deceleration and the regenerative braking map in which the preferred deceleration is reflected is constructed and used, thereby enabling implementation of an appropriate regenerative braking deceleration that suits the driver's tendencies.

Because a preferred deceleration level varies depending on the driver, if a deceleration during actual regenerative braking does not satisfy the preferred deceleration level, there may be many cases in which the driver does not use regenerative braking.

In order to solve this problem, in the present disclosure, a preferred deceleration in a driver's coast regeneration situation, i.e., in a situation in which the driver takes his/her foot off the accelerator pedal and the vehicle speed is the set speed (for example, 30 km/h) or higher, is learned, and the existing regenerative braking map is corrected based on a result of learning to construct a personalized regenerative braking map.

As a result, the personalized regenerative braking map may be used to control regenerative braking of the vehicle, thereby being capable of implementing the regenerative braking deceleration that suits the driver's tendencies and increasing driver's use of regenerative braking.

In addition, as the driver preferred entry slope is used when entering the regenerative braking, the regenerative braking torque may be gently changed at the time of entering regenerative braking, thereby being capable of solving problems, such as sudden changes in the vehicle speed and occurrence of a sense of incongruity when entering regenerative braking.

Conventionally, there were many cases in which drivers did not use regenerative braking because they were concerned about motion sickness, etc. due to a sense of incongruity caused by a sudden speed change even when they wanted to use regenerative braking. The degree of the sense of incongruity or discomfort varies depending on the driver.

In the present disclosure, in order to solving the problems of sudden changes in the vehicle speed and occurrence of a sense of incongruity, the preferred deceleration slope is determined by learning the driving data of the corresponding driver, such as braking and deceleration data, and is applied as the deceleration slope for entering regenerative braking when the personalized regenerative braking map is used. Thereby, the vehicle speed may be gently changed, and occurrence of a sense of incongruity felt by the driver may be prevented.

As is apparent from the above description, a method of personalizing regenerative braking method of a vehicle according to the present disclosure enables personalized regenerative braking control based on different preferred deceleration and brake pedal sensitivity for each driver, thereby being capable of inducing a driver to more actively use regenerative braking.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of personalizing regenerative braking of a vehicle comprising:
collecting, by a controller, driving data of the vehicle;
determining, by the controller, that a braking situation of the vehicle is a regenerative braking situation while coasting based on the driving data collected while the vehicle is driving;
receiving, by the controller, a brake pedal sensor signal depending on operation of a brake pedal by a driver during regenerative braking while coasting;
determining, by the controller, a driver preferred deceleration based on a brake pedal input value indicated by the brake pedal sensor signal whenever the driver operates the brake pedal;
generating, by the controller, a personalized regenerative braking map based on the determined driver preferred deceleration information; and
controlling, by the controller, operations of the vehicle based on the personalized regenerative braking map.

2. The method of claim 1, wherein the controlling, by the controller, the vehicle based on the personalized regenerative braking map further comprising:
controlling, by the controller, a display device of the vehicle to output a message configured to recommend experience of a regenerative braking personalization mode; and
if the driver selects the experience of the regenerative braking personalization mode through an input device, controlling, by the controller, regenerative operation of a motor with a regenerative braking torque determined by the personalized regenerative braking map.

3. The method of claim 1, wherein, in determining the driver preferred deceleration, the controller determines the driver preferred deceleration based on the brake pedal input value indicated by the brake pedal sensor signal input during the regenerative braking while coasting when a vehicle speed is a set speed or higher.

4. The method of claim 1, wherein the controller is provided with a brake pedal map configured such that a braking deceleration is set to a value depending on the brake pedal input value,
wherein determining the driver preferred deceleration comprises:
determining an average value of peak values of brake pedal input values indicated by brake pedal sensor signals collected whenever the driver operates the brake pedal; and
determining a deceleration corresponding to the average value of the peak values in the brake pedal map as the driver preferred deceleration.

5. The method of claim 1, wherein the controller is provided with a brake pedal map configured such that a braking deceleration is set to a value depending on the brake pedal input value,
wherein determining the driver preferred deceleration comprises:
determining peak values of brake pedal input values indicated by brake pedal sensor signals collected whenever the driver operates the brake pedal;
determining decelerations corresponding to the respective peak values of the brake pedal input values from the brake pedal map; and
determining an average value of the determined decelerations as the driver preferred deceleration.

6. The method of claim 1, wherein:
the personalized regenerative braking map is a map configured such that a regenerative braking torque is set to a value depending on a vehicle speed; and
the set regenerative braking torque in the personalized regenerative braking map is a regenerative braking torque configured to be capable of controlling a vehicle deceleration to be the driver preferred deceleration during the regenerative braking while coasting.

7. The method of claim 6, wherein the controller is provided with a plurality of regenerative braking stages set to be selectable and a preset regenerative braking map provided for each of the regenerative braking stages,
wherein, in generating the personalized regenerative braking map, the controller generates the personalized regenerative braking map based on map values of the preset regenerative braking map provided for each of the regenerative braking stages and the driver preferred deceleration.

8. The method of claim 7, wherein the preset regenerative braking map is a map configured such that a regenerative braking torque is set to a value depending on the vehicle speed,
wherein the regenerative braking torque is set to be capable of controlling the vehicle deceleration to be a deceleration predetermined for each of the regenerative braking stages.

9. The method of claim 8, wherein, in generating the personalized regenerative braking map, the controller generates the personalized regenerative braking map by determining regenerative braking torques, which are map values of the personalized regenerative braking map, by interpolation or extrapolation for an entire range of the vehicle speed based on the deceleration predetermined for each of the regenerative braking stages, the driver preferred deceleration, and the regenerative braking torque for each vehicle speed of the preset regenerative braking map.

10. The method of claim 8, wherein:
in the personalized regenerative braking map, the regenerative braking torque in a vehicle speed range higher than or equal to a predetermined reference vehicle speed is set to a constant value corresponding to the driver preferred deceleration; and
in the preset regenerative braking map provided for each of the regenerative braking stages, the regenerative braking torque in the vehicle speed range higher than or equal to the reference vehicle speed is set to a constant value corresponding to the deceleration predetermined for each of the regenerative braking stages.

11. The method of claim 1, wherein the controlling, by the controller, the vehicle based on the personalized regenerative braking map further comprising:
controlling, by the controller, regenerative operation of a motor of the vehicle with a regenerative braking torque determined by the personalized regenerative braking map, in a state in which a regenerative braking personalization mode is selected by the driver.

12. The method of claim 1, further comprising:
determining, by the controller, a driver preferred regenerative braking entry slope from the brake pedal sensor signal input whenever the driver operates the brake pedal,
wherein, if the driver takes his/her foot off an accelerator pedal while the vehicle is driving, the controller changes the regenerative braking torque at the driver preferred regenerative braking entry slope from a point in time when the accelerator pedal is off until the regenerative braking torque reaches a regenerative braking torque corresponding to a map value of the personalized regenerative braking map.

13. The method of claim 12, wherein, if the driver takes his/her foot off the accelerator pedal while the vehicle is driving when the vehicle speed is a set speed or higher, the controller changes the regenerative braking torque at the driver preferred regenerative braking entry slope from the point in time when the accelerator pedal is off.

14. The method of claim 12, wherein determining the driver preferred regenerative braking entry slope comprises:
determining deceleration slopes from brake pedal sensor signals input whenever the driver operates the brake pedal, during regenerative braking while coasting;
determining an average value of the deceleration slopes whenever the driver operates the brake pedal; and
converting the average value of the deceleration slopes into a regenerative braking torque slope and determining the converted regenerative braking torque slope as the driver preferred regenerative braking entry slope.

15. The method of claim 14, wherein, in determining the deceleration slopes, the controller determines each of the deceleration slope as a value obtained by differentiating a corresponding one of the brake pedal sensor signals with respect to time.

16. The method of claim 12, wherein, in determining the driver preferred regenerative braking entry slope, the controller determines the driver preferred regenerative braking entry slope from the brake pedal sensor signal input during regenerative braking while coasting when the vehicle speed is a set speed or higher.
